(19) United States
(12) Patent Application Publication
(10) Pub. No.: US 2009/0011841 A1
(43) Pub. Date: Jan. 8, 2009

(54) Thrust washer for universal joint cross

(75) Inventor: Dawhorng D. Wang, Perrysburg, OH (US)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: Torque-Traction Technologies LLC

(21) Appl. No.: 11/825,084

(22) Filed: Jul. 3, 2007

(51) Int. Cl. F16D 3/40

(52) U.S. Cl. 464/14; 464/132

(57) ABSTRACT

A cross for a universal joint includes a body including an outwardly extending trunnion and a bearing cup mounted on the trunnion. A thrust washer is disposed between the trunnion and the bearing cup. The thrust washer includes an outer edge portion, a spacer portion that extends from the outer edge portion and is curved in cross sectional shape, a spring portion that extends generally radially inwardly from the spacer portion and is shaped generally in the form of a hollow cone, and an inner lip portion that extends inwardly from the spring portion. The thrust washer absorbs thrust loads that occur between an outer end surface of the trunnion and an inner surface of a closed end of the bearing cup and takes up any axial looseness therebetween.

### BACKGROUND OF THE INVENTION

This invention relates in general to thrust washers that are disposed between the outer ends of trunnions and the inner surfaces of bearing cups in universal joint crosses. More specifically, this invention relates to an improved structure for such a thrust washer.

Universal joints are well known devices that provide a driving connection between two members adapted to rotate about non-aligned axes of rotation. Universal joints are widely used between rotatable drive shaft sections in vehicle drive train systems. A typical universal joint includes a cross having a central body portion with four cylindrical trunnions extending outwardly therefrom. The trunnions are oriented in a single plane and extend at right angles relative to one another. A hollow cylindrical bearing cup having a cylindrical outside wall and a circular end wall is mounted on the end of each of the trunnions. A plurality of bearings, such as needle bearings or roller bearings, are provided between the trunnion and the associated bearing cup to permit relative rotational movement therebetween. The bearing cups that are mounted on a first opposed pair of the trunnions can be connected to a first end yoke secured to an end of a first drive shaft section, while the bearing cups mounted on a second opposed pair of the trunnions can be connected to a second end yoke secured to an end of a second drive shaft section.

When the bearing cups are mounted on the trunnions, the end walls of the bearing cups are disposed adjacent to the axially outer ends of the trunnions and bearings. If the end walls of the bearing cups fit tightly against the axially outer ends of the trunnions and bearings, friction between the surfaces during operation of the universal joint can generate heat and cause premature wear. On the other hand, if the end walls of the bearing cups fit loosely on the trunnions, the cross can undesirably move relative to the bearing cups during operation of the universal joint, which can result in imbalances and generate undesirable noise and vibrations.

To address these situations, it is known to provide a thrust washer between the end wall of a bearing cup and the axially outer end of the associated trunnion. A typical thrust washer is formed from a wear-resistant material, such as plastic, that can absorb the thrust loads that occur between the end wall of a bearing cup and the axially outer end of the associated trunnion and take up any looseness therebetween.

### SUMMARY OF THE INVENTION

This invention relates to an improved structure for a thrust washer that is adapted to be disposed between a trunnion and a bearing cup of a universal joint cross. The cross includes a body including an outwardly extending trunnion and a bearing cup mounted on the trunnion. A thrust washer is disposed between the trunnion and the bearing cup. The thrust washer includes an outer edge portion, a spacer portion that extends from the outer edge portion and is curved in cross sectional shape, a spring portion that extends generally radially inwardly from the spacer portion and is shaped generally in the form of a hollow cone, and an inner lip portion that extends inwardly from the spring portion. The thrust washer absorbs thrust loads that occur between an outer end surface of the trunnion and an inner surface of a closed end of the bearing cup and takes up any axial looseness therebetween.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is an elevational view, partially in cross section, of a cross for a universal joint including a first embodiment of a thrust washer in accordance with this invention.

FIG. 2 is an enlarged sectional elevational view of a portion of one of the trunnions of the cross and the first embodiment of the thrust washer illustrated in FIG. 1.

FIG. 3 is a further enlarged sectional elevational view of the first embodiment of the thrust washer illustrated in FIG. 1.

FIG. 4 is a perspective view of the first embodiment of the thrust washer illustrated in FIGS. 1, 2, and 3.

FIG. 5 is a top plan view of the first embodiment of the thrust washer illustrated in FIGS. 1 through 4.

FIG. 6 is a perspective view of a second embodiment of a thrust washer in accordance with this invention.

FIG. 7 is a top plan view of the second embodiment of the thrust washer illustrated in FIG. 6.

FIG. 8 is a perspective view of a third embodiment of a thrust washer in accordance with this invention.

FIG. 9 is a top plan view of the third embodiment of the thrust washer illustrated in FIG. 8.

FIG. 10 is an enlarged sectional elevational view of a portion of one of the trunnions of the cross illustrated in FIG. 1 and a fourth embodiment of the thrust washer in accordance with this invention.

FIG. 11 is a perspective view of the fourth embodiment of the thrust washer illustrated in FIG. 10.

FIG. 12 is a top plan view of the fourth embodiment of the thrust washer illustrated in FIGS. 10 and 11.

FIG. 13 is a perspective view of a fifth embodiment of a thrust washer in accordance with this invention.

FIG. 14 is a top plan view of the fifth embodiment of the thrust washer illustrated in FIG. 13.

FIG. 15 is a perspective view of a sixth embodiment of a thrust washer in accordance with this invention.

FIG. 16 is a top plan view of the sixth embodiment of the thrust washer illustrated in FIG. 15.

### DETAILED DESCRIPTION OF THE PREFERRED EMBODIMENTS

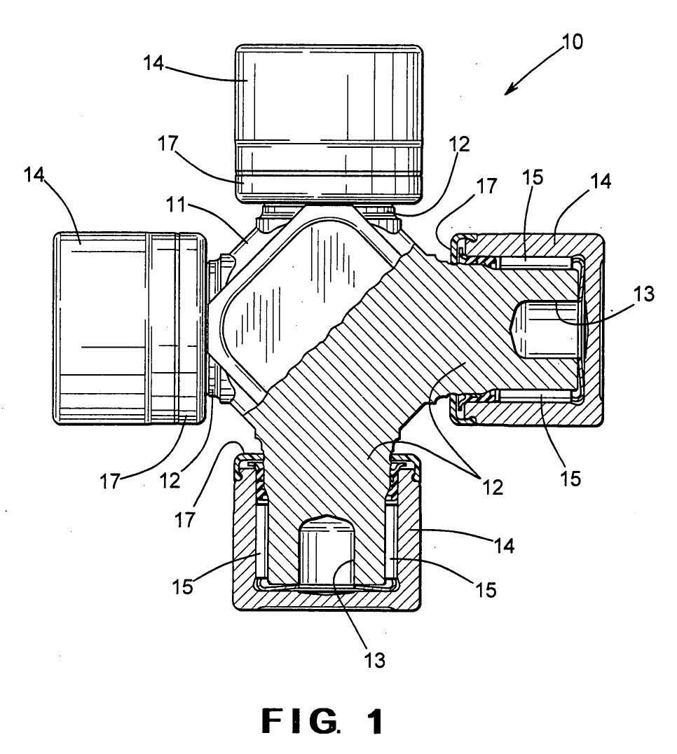

Referring now to the drawings, there is illustrated in FIG. 1 a cross, indicated generally at 10, in accordance with this invention. The cross 10 is adapted to form a portion of a universal joint (not shown), such as described above and conventionally used in drive train system. The illustrated cross 10 includes a central body 11 having a plurality of trunnions 12 extending outwardly from the body 11. In the illustrated embodiment, four of such trunnions 12 are formed integrally with the body 11. The illustrated trunnions 12 are disposed at right angles relative to one another and are oriented so as to lie in a single plane, although such is not required. The illustrated trunnions 12 are generally cylindrical in shape and define respective axes of rotation, although again such is not required.

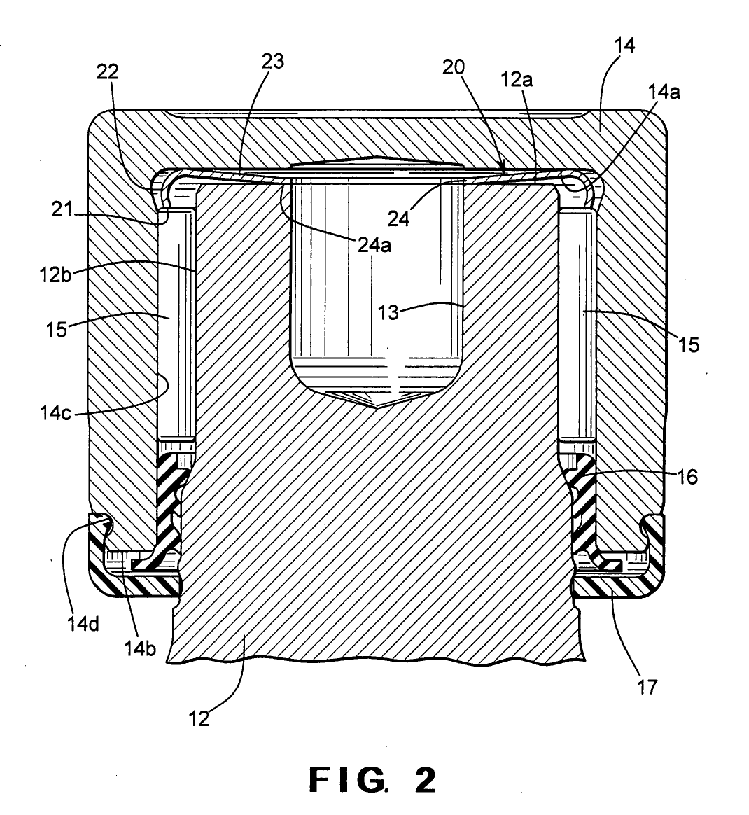

As best shown in FIG. 2, each of the illustrated trunnions 12 is generally cylindrical in shape, having an outer end surface 12a and an outer cylindrical surface 12b. However, the trunnions 12 may be formed having any desired shape or combination of shapes and need not be formed integrally with the central body 11. Each of the illustrated trunnions 12 has an internal cavity 13 provided therein. The internal cavities 13 are conventional in the art and function as reservoirs for lubricant. In lieu of such internal cavities 13, each of the trunnions 12 may be formed having an internal lubricant passageway (not shown) that extends from a central internal cavity (not shown) located within the central body 11. Alternatively, if desired, the trunnions 12 may be formed having no such internal cavities 13 or lubricant passageways.

A bearing cup 14 is supported on the end of each of the trunnions 12 of the cross 10. Each of the bearing cups 14 is generally hollow and cylindrical in shape, including a closed end 14a, an opened end 14b, and an inner cylindrical surface 14c. When mounted on the end of the associated trunnion 12, the closed end 14a of the bearing cup 14 is disposed adjacent to the outer end surface 12a of the trunnion 12, while the inner cylindrical surface 14c of the bearing cup 14 is disposed concentrically about the outer cylindrical surface 12b of the trunnion 12. The diameter defined by the inner cylindrical surface 14c of the bearing cup 14 is somewhat larger than the diameter defined by the outer cylindrical surface 12b of the trunnion 12, thus defining an annular space therebetween. A groove 14d (see FIG. 2) is provided in the outer surface of the illustrated bearing cup 14 adjacent to the opened end 14b thereof. The illustrated groove 14d extends continuously and circumferentially about the bearing cup 14, although such is not required. The purpose for this groove 14d will be explained below.

A plurality of conventional roller bearings 15 (only two are illustrated on each of the trunnions 12) is disposed in the annular space in a circumferential array about each of the trunnions 12. The roller bearings 15 have outer ends that are located adjacent to the closed end of the bearing cup 14 and inner ends that are located adjacent to the opened end 14b of the bearing cup 14. As is well known, the roller bearings 15 are provided to facilitate rotational movement of the bearing cup 14 relative to the trunnion 12.

A seal 16 is provided about the opened end 14b of each of the bearing cups 14. The seals 16 are conventional in the art and may, as shown in FIG. 2, be formed from a resilient or elastomeric material. Each of the illustrated seals 16 is annular in shape and extends between the inner cylindrical surface 14c of the bearing cup 14 and the outer cylindrical surface 12b of the associated trunnion 12. The seals 16 prevent lubricant from flowing out of the regions of the roller bearings 15 though the opened ends 14b of the bearing cups 14. The seals 16 also prevent dirt, water, and other contaminants from entering through the opened ends 14b of the bearing cups 14 into the regions of the roller bearings 15. If desired, each of the annular seals 16 may be supported on a rigid support ring (not shown) that is, in turn, supported on the bearing cup 12. Such support rings are conventional in the art and typically include a first flange portion that extends radially inwardly toward the trunnion 12 between the innermost ends of the roller bearings 15 and the annular seal 16, a body portion that extends axially and is press fit or otherwise secured to the inner cylindrical surface 14c of the bearing cup 14, and a second flange portion that extends radially outwardly adjacent to the opened end 14b of the bearing cup 14.

A dust guard 17 is also provided about the opened end 14b of each of the bearing cups 14. The dust guards 17 are also conventional in the art and may each be formed from a relatively rigid plastic material. Each of the dust guards 17 is annular in shape and extends from the groove 14d provided in the outer surface of the bearing cup 14 into engagement with the associated trunnion 12. The dust guards 17 are provided to protectively cover the seals 16 and to prevent the bearing cups 14 from being accidentally removed from the trunnion 12 prior to installation in a universal joint.

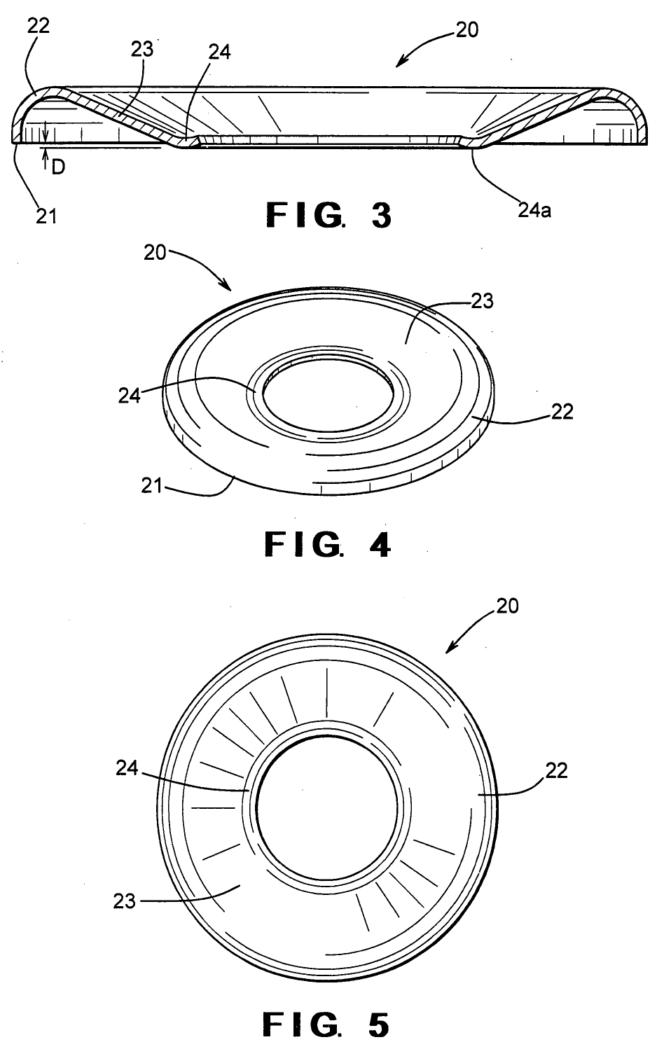

A first embodiment of a thrust washer, indicated generally at 20, is disposed between the outer end surface 12a of each of the trunnions 12 and the associated inner surface of each of the closed end portions 14a of the bearing cups 14. The structure of the first embodiment of the thrust washer 20 is illustrated in detail in FIGS. 3 through 5. As shown therein, the first embodiment of the thrust washer 20 is generally annular in shape and includes an outer edge portion 21. The outer edge portion 21 of the illustrated thrust washer 20 abuts the outer ends of the roller bearing 15. The first embodiment of the thrust washer 20 also includes a spacer portion 22 that extends from the outer edge portion 21 into engagement with inner surface of the closed end 14a of the bearing cup 14. In the illustrated embodiment, the spacer portion 22 is curved in cross sectional shape, being defined by a generally constant radius. However, the spacer portion 22 of the illustrated thrust washer 20 may be formed having any desired cross sectional shape.

The first embodiment of the thrust washer 20 further includes a spring portion 23 that extends generally radially inwardly from the spacer portion 22 of the thrust washer 20. In the illustrated embodiment, the spring portion 23 is formed generally in the shape of a conical washer, having a generally linear cross sectional shape that extends at an angle relative to the rotational axis of the trunnion 12. However, the spring portion 23 of the illustrated thrust washer 20 may be formed having any desired shape. Lastly, the first embodiment of the thrust washer 20 includes an inner lip portion 24 that extends generally radially inwardly from the spring portion 23 of the thrust washer 20. In the illustrated embodiment, the inner lip portion 24 is formed generally in the shape of a flat washer, having a generally linear cross sectional shape that extends perpendicularly relative to the rotational axis of the trunnion 12. However, the inner lip portion 24 of the illustrated thrust washer 20 may be formed having any desired shape. The inner lip portion 24 of the illustrated thrust washer 20 has an inner surface 24a that abuts the outer end surface 12a of the trunnion 12.

Preferably, the first embodiment of the thrust washer 20 is formed from a single piece of a material, although such is not required. Any desired material may be used to form the first embodiment of the thrust washer 20. For example, the thrust washer 20 can be formed from a conventional spring steel material, such as grade C1075 steel. Also, the first embodiment of the thrust washer 20 is preferably formed having a relatively uniform thickness, such as standard gage number twenty-four steel. However, the thrust washer 20 may be formed having any desired thickness or combination of thicknesses.

To assemble the cross 10, the thrust washer 20 is initially disposed within the bearing cup 14 adjacent to the inner surface of the closed end 14a. Then, the roller bearings 15 are disposed within the bearing cup 14 adjacent to the inner cylindrical surface 14c. Next, the seal 16 and the dust guard 17 are supported on the opened end 14b of the bearing cup 14. Lastly, the internal cavity 13 of the trunnion 12 is filled with lubricant, and the bearing cup 14 and associated components are disposed co-axially about the trunnion 12, as shown in FIGS. 1 and 2.

When the bearing cup 14 is disposed about the trunnion 21, the outer edge portion 21 of the thrust washer 20 is disposed adjacent to the outer ends of the roller bearing 15. At the same time, the spacer portion 22 of the thrust washer 20 extends from the outer edge portion 21 into engagement with the inner surface of the closed end 14a of the bearing cup 14. Also, the spring portion 23 of the thrust washer 20 extends generally radially inwardly from the spacer portion 22 to the lip portion 24, wherein the inner surface 24a thereof abuts the outer end surface 12a of the trunnion 12.

The thrust washer 20 can resiliently absorb thrust loads that occur between the outer end surface 12a of the trunnion 12 and the inner surface of the closed end 14a of the bearing cup 14 and can take up any axial looseness therebetween. To accomplish this, the spring portion 23 of the thrust washer 20 reacts resiliently between the outer end surface 12a of the trunnion 12 and the inner surface of the closed end 14a of the bearing cup 14. At the same time, however, the thrust washer 20 can maintain a predetermined spacing between the closed end 14a of the bearing cup 14 and the roller bearings 15. To accomplish this, the spacer portion 22 of the thrust washer reacts relatively inflexibly between the inner surface of the closed end 14a of the bearing cup 14 and the outer ends of the roller bearing 15.

As discussed above, the cross 10 can form a portion of an otherwise conventional universal joint to provide a driving connection between two members adapted to rotate about non-aligned axes of rotation, such as first and second rotatable drive shaft sections in a vehicle drive train system. To accomplish this, the bearing cups 14 that are mounted on a first opposed pair of the trunnions 12 can be connected to a first end yoke (not shown) secured to an end of the first drive shaft section, while the bearing cups 14 mounted on a second opposed pair of the trunnions 12 can be connected to a second end yoke (not shown) secured to an end of the second drive shaft section.

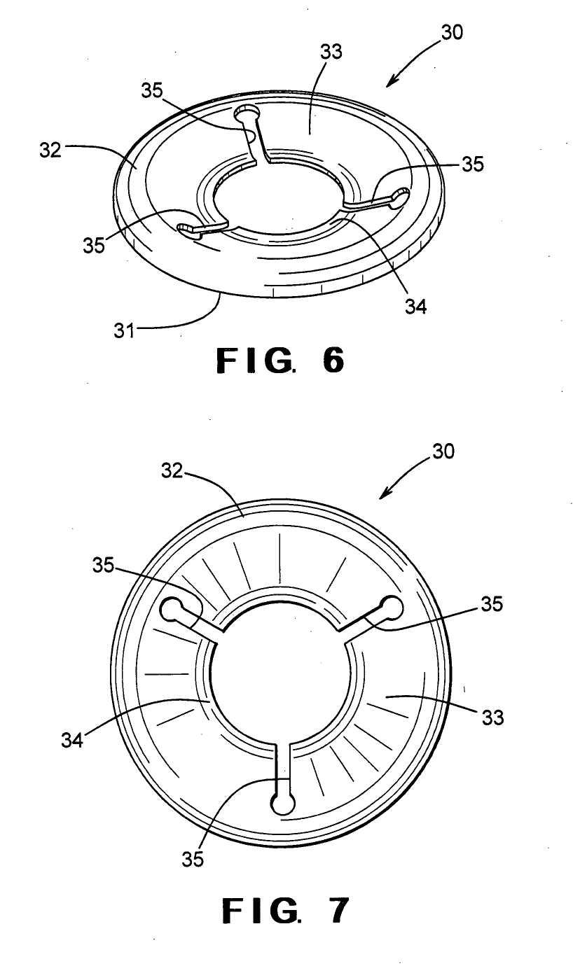

FIGS. 6 and 7 illustrate a second embodiment of a thrust washer, indicated generally at 30, in accordance with this invention. The second embodiment of the thrust washer 30 is similar to the first embodiment of the thrust washer 20 described above and includes an outer edge portion 31, a spacer portion 32 that extends from the outer edge portion 31 into engagement with inner surface of the closed end 14a of the bearing cup 14, a spring portion 33 that extends inwardly from the spacer portion 32, and an inner lip portion 34 that extends generally radially inwardly from the spring portion 33. Additionally, however, the second embodiment of the thrust washer 30 has a plurality of slots 35 provided therein that provide additional flexibility thereto. In the illustrated embodiment, three of such slots 35 are equidistantly provided in the second embodiment of the thrust washer 30. However, any desired number of such slots 35 may be provided. The illustrated slots 35 extend generally radially outwardly from the inner lip portion 34 to the spacer portion 32. However, the slots 35 may be formed having any desired shape or combination of shapes. The second embodiment of the thrust washer 30 can be used in the cross 10 in the same manner as described above in connection with the first embodiment of the thrust washer 20.

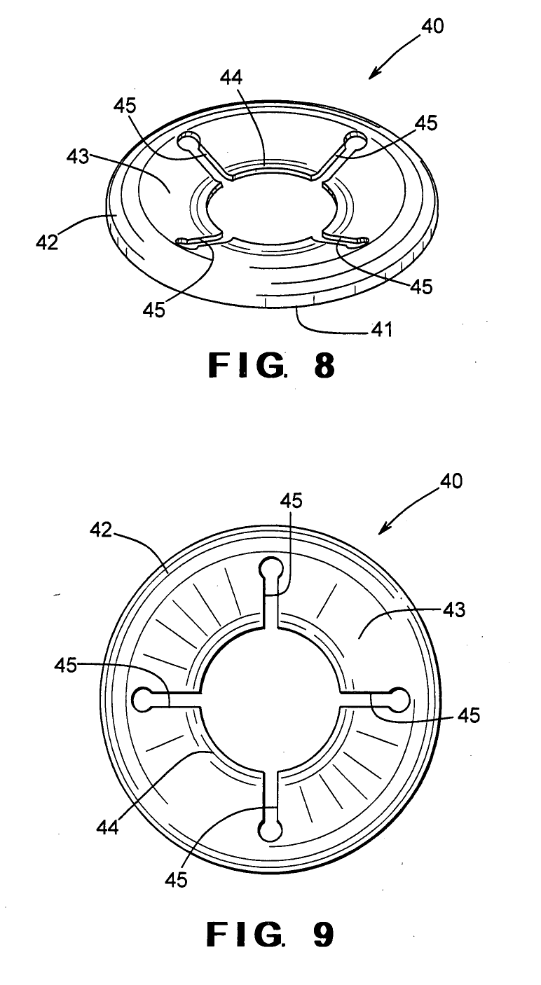

FIGS. 8 and 9 illustrate a third embodiment of a thrust washer, indicated generally at 40, in accordance with this invention. The third embodiment of the thrust washer 40 is similar to the first embodiment of the thrust washer 20 described above and includes an outer edge portion 41, a spacer portion 42 that extends from the outer edge portion 41 into engagement with inner surface of the closed end 14a of the bearing cup 14, a spring portion 43 that extends inwardly from the spacer portion 42, and an inner lip portion 44 that extends generally radially inwardly from the spring portion 43. Additionally, however, the third embodiment of the thrust washer 40 has four slots 45 equidistantly provided therein. The illustrated slots 45 extend generally radially outwardly from the inner lip portion 44 to the spacer portion 42. However, the slots 45 may be formed having any desired shape or combination of shapes. The third embodiment of the thrust washer 40 can be used in the cross 10 in the same manner as described above in connection with the first embodiment of the thrust washer 20.

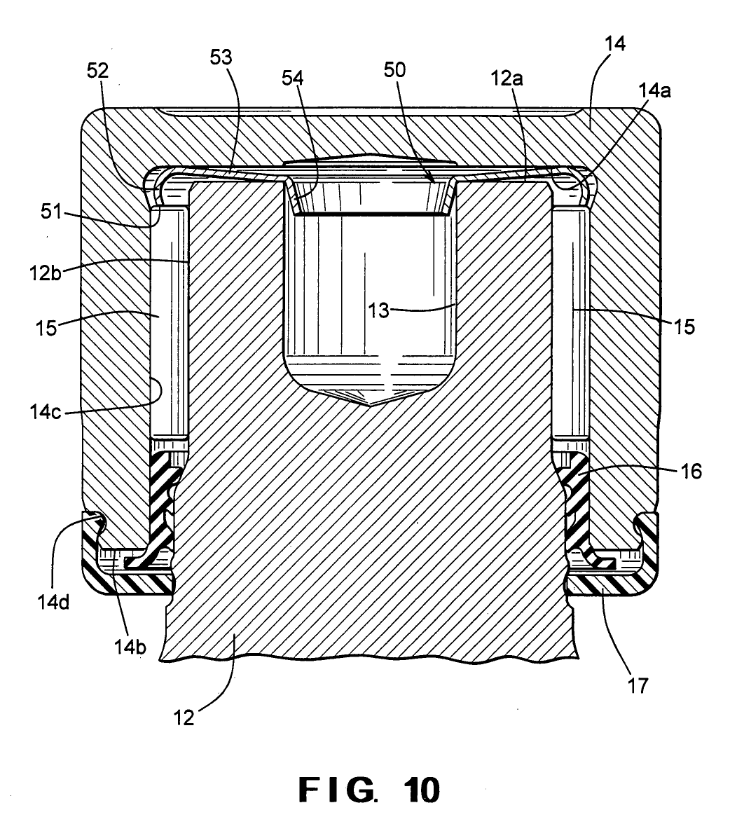

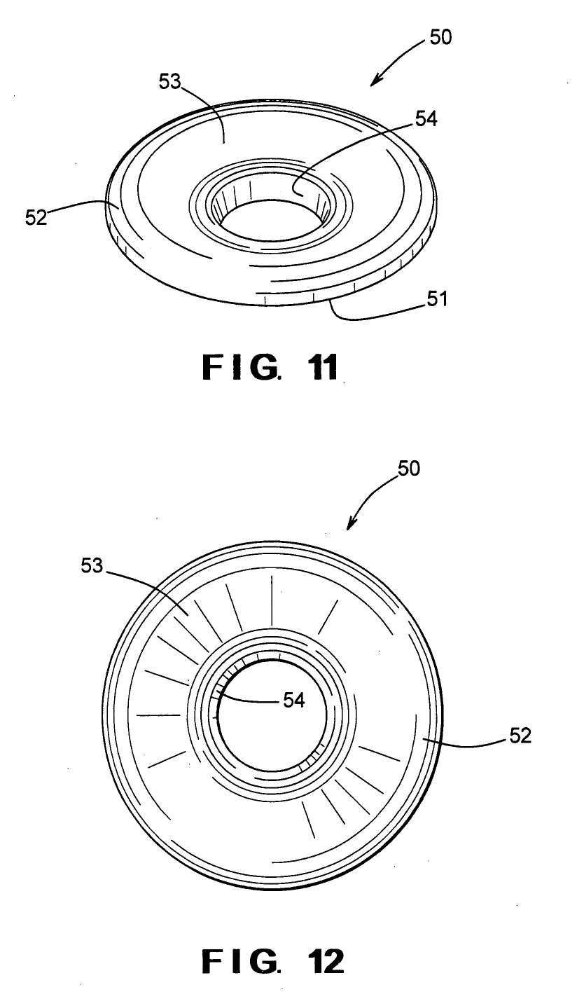

FIGS. 10, 11, and 12 illustrate a fourth embodiment of a thrust washer, indicated generally at 50, in accordance with this invention. The fourth embodiment of the thrust washer 50 is similar to the first embodiment of the thrust washer 20 described above and includes an outer edge portion 51, a spacer portion 52 that extends from the outer edge portion 51 into engagement with inner surface of the closed end 14a of the bearing cup 14, a spring portion 53 that extends inwardly from the spacer portion 52, and an inner lip portion 54 that extends inwardly from the spring portion 53. In this embodiment, however, the inner lip portion 54 is shaped generally in the form of a hollow cone. As best shown in FIG. 10, the inner lip portion 54 extends at least partially within the internal cavity 13 of the trunnion 12 and can function to precisely position the thrust washer 50 relative thereto. The fourth embodiment of the thrust washer 50 can be used in the cross 10 in the same manner as described above in connection with the first embodiment of the thrust washer 20.

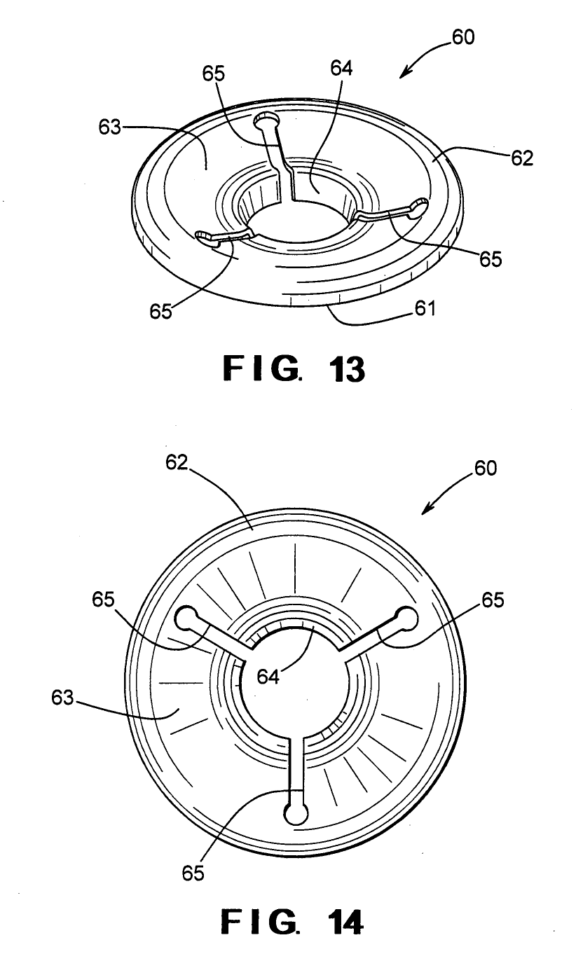

FIGS. 13 and 14 illustrate a fifth embodiment of a thrust washer, indicated generally at 60, in accordance with this invention. The fifth embodiment of the thrust washer 60 is similar to the fourth embodiment of the thrust washer 50 described above and includes an outer edge portion 61, a spacer portion 62 that extends from the outer edge portion 61 into engagement with inner surface of the closed end 14a of the bearing cup 14, a spring portion 63 that extends inwardly from the spacer portion 62, and an inner lip portion 64 that extends inwardly from the spring portion 63 in the general shape of a hollow cone. Additionally, however, the fifth embodiment of the thrust washer 60 has a plurality of slots 65 provided therein that provide additional flexibility thereto. In the illustrated embodiment, three of such slots 65 are equidistantly provided in the fifth embodiment of the thrust washer 60. However, any desired number of such slots 65 may be provided. The illustrated slots 65 extend generally radially outwardly from the inner lip portion 64 to the spacer portion 62. However, the slots 65 may be formed having any desired shape or combination of shapes. The fifth embodiment of the thrust washer 60 can be used in the cross 10 in the same manner as described above in connection with the fourth embodiment of the thrust washer 50.

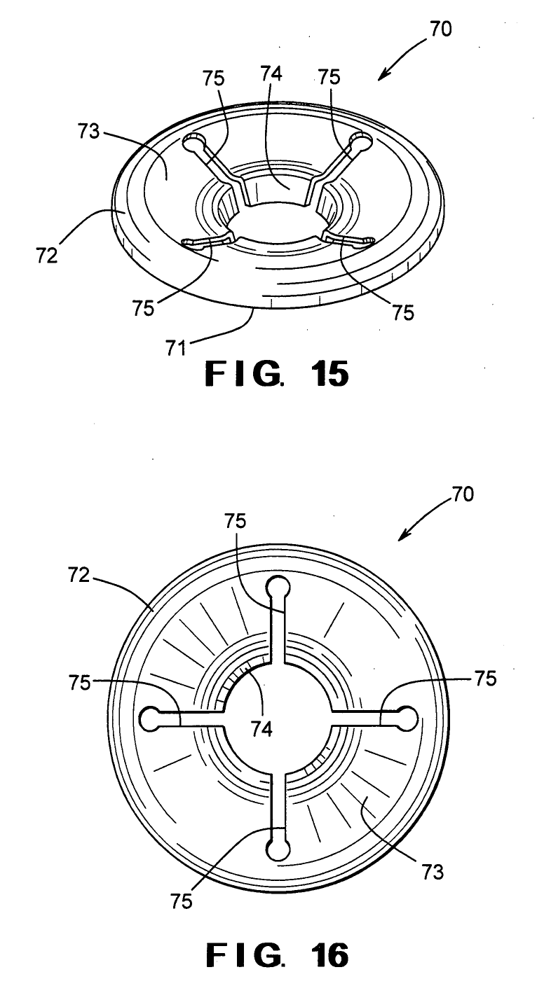

FIGS. 15 and 16 illustrate a sixth embodiment of a thrust washer, indicated generally at 70, in accordance with this invention. The sixth embodiment of the thrust washer 70 is similar to the fourth embodiment of the thrust washer 50 described above and includes an outer edge portion 71, a spacer portion 72 that extends from the outer edge portion 71 into engagement with inner surface of the closed end 14a of the bearing cup 14, a spring portion 73 that extends inwardly from the spacer portion 72, and an inner lip portion 74 that extends inwardly from the spring portion 73 in the general shape of a hollow cone. Additionally, however, the sixth embodiment of the thrust washer 70 has four slots 75 equidistantly provided therein. The illustrated slots 75 extend generally radially outwardly from the inner lip portion 74 to the spacer portion 72. However, the slots 75 may be formed having any desired shape or combination of shapes. The sixth embodiment of the thrust washer 70 can be used in the cross 10 in the same manner as described above in connection with the fourth embodiment of the thrust washer 50.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A thrust washer adapted to be disposed between a trunnion and a bearing cup of a universal joint cross, the thrust washer comprising:
an outer edge portion;
a spacer portion that extends from the outer edge portion and is curved in cross sectional shape;
a spring portion that extends generally radially inwardly from the spacer portion and is shaped generally in the form of a hollow cone; and
an inner lip portion that extends inwardly from the spring portion.

2. The thrust washer defined in claim 1 wherein the spacer portion is defined by a generally constant radius.

3. The thrust washer defined in claim 1 wherein the spring portion has a generally linear cross sectional shape.

4. The thrust washer defined in claim 1 wherein the inner lip portion extends generally radially inwardly from the spring portion.

5. The thrust washer defined in claim 1 wherein the inner lip portion is shaped generally in the form of a hollow cone.

6. The thrust washer defined in claim 1 further including a slot provided in the thrust washer.

7. The thrust washer defined in claim 6 wherein the slot extends generally radially outwardly from the inner lip portion to the spacer portion.

8. The thrust washer defined in claim 1 further including a plurality of slots provided in the thrust washer.

9. The thrust washer defined in claim 8 wherein each of the slots extends generally radially outwardly from the inner lip portion to the spacer portion.

10. The thrust washer defined in claim 1 wherein the spacer portion is defined by a generally constant radius, and wherein the spring portion has a generally linear cross sectional shape.

11. A cross for a universal joint comprising:
a body including an outwardly extending trunnion;
a bearing cup mounted on the trunnion; and
a thrust washer disposed between the trunnion and the bearing cup, the thrust washer including an outer edge portion, a spacer portion that extends from the outer edge portion and is curved in cross sectional shape, a spring portion that extends generally radially inwardly from the spacer portion and is shaped generally in the form of a hollow cone, and an inner lip portion that extends inwardly from the spring portion.

12. The cross defined in claim 11 wherein the spacer portion is defined by a generally constant radius.

13. The cross defined in claim 11 wherein the spring portion has a generally linear cross sectional shape.

14. The cross defined in claim 11 wherein the inner lip portion extends generally radially inwardly from the spring portion.

15. The cross defined in claim 11 wherein the inner lip portion is shaped generally in the form of a hollow cone.

16. The cross defined in claim 11 further including a slot provided in the thrust washer.

17. The cross defined in claim 16 wherein the slot extends generally radially outwardly from the inner lip portion to the spacer portion.

18. The cross defined in claim 11 further including a plurality of slots provided in the thrust washer.

19. The cross defined in claim 18 wherein each of the slots extends generally radially outwardly from the inner lip portion to the spacer portion.

20. The cross defined in claim 11 wherein the spacer portion is defined by a generally constant radius, and wherein the spring portion has a generally linear cross sectional shape.
